(19) United States
(12) Patent Application Publication
(10) Pub. No.: US 2006/0014406 A1
(43) Pub. Date: Jan. 19, 2006

(54) Safety system for current outlets, fluorescent tube, sockets, lamp holders and the like

(76) Inventor: Camilo Abraham Brahim, Tucuman (AR)

Correspondence Address: BACHMAN & LAPOINTE, P.C., 900 CHAPEL STREET, SUITE 1201, NEW HAVEN, CT, 06510, US

(21) Appl. No.: 11/176,460

(22) Filed: Jul. 7, 2005

(30) Foreign Application Priority Data
Jul. 7, 2004 (AR) P-04-01-02404

(51) Int. Cl. H01R 13/44

(52) U.S. Cl. 439/139

(57) ABSTRACT

Device housed into a container formed between the housings of a current outlet from which respective blocking arms project from at least two of the housings provided for the pins of a plug. At the lower base of the device, a resilient structure is provided which separates the device from the container bottom and, at the upper base, there are corresponding contacts, each of which has a rear portion encompassing at least partially the side of the device and a front portion projecting to the front. Displacement of the device compresses the resilient structure and connects the rear portion of the contacts to the metal portion of the corresponding housing and the front portion of the contacts to corresponding terminals electrically connected to respective terminal points of power supply cables, thus closing the circuit.

### BACKGROUND OF THE INVENTION

1. Field of the Invention

The instant invention relates to a safety system for current outlets, fluorescent tube sockets, lamp holders and the like.

2. Prior Art

Several systems for protecting against electric current shocks received due to lack of care, inexpertness or lack of knowledge are already known.

Already known are outlets provided with snap fit covers at the inlet of plug sockets in which pins may only be introduced after removing such covers.

Embodiments wherein covers may de displaced to the sides for clearing the inlets to plug sockets are also known.

Among the disadvantages related to the first mentioned solution, covers should be withdrawn in order to effect the electrical connection and such covers should have a certain strength in order to make the withdrawal action difficult in order to guarantee the protection sought.

On their part, sliding covers may be actuated by a lug which is ease to remove, even by children.

A third solution comprises two parallel plates provided with the openings required to carry out the connection, but one of said plates is engaged to a resilient means causing displacement thereof, such that the openings in the plate do not mate with openings on the other plate.

In this way, alignment between inlet holes and electric installation poles is interrupted, such that the openings be dissimulated not to call the attention of unskilled persons.

In order to connect a device, plug pins are introduced into the outer plate openings and such plate is displaced to one side counteracting the resistance of the resilient means until holes on both plates are aligned and allow the introduction of pins, thus effecting the connection.

Other safety means is obtained by replacing round pins for flat pins which, upon reducing the access surface inside the socket, limits the amount of objects which may be introduced inside the plug sockets or housings.

In all mentioned cases, when plug pins are introduced, these contact the corresponding housings which in turn are connected to the power supply.

In the instant invention, any element introduced into the housing of the outlet will not close the circuit since said housings are not connected to the power supply.

In fact, plug pins or any other conductor member will be able to close the electric circuit provided both are introduced in the respective housing simultaneously, since only in this way they may actuate on the blocking arms of a device provided with the means required to close the circuit.

The invention allows using almost all matrixes in use at present, with small modifications for adapting them to the new shapes and characteristics.

The system of the invention includes a device which may be placed in any kind of outlet, fluorescent tube socket, lamp holder or the like to adapt existing devices in order that they may take advantage of the invention.

### BRIEF DESCRIPTION OF THE DRAWINGS

FIG. 1 is a perspective view showing an outlet cover wherein the openings for the pins to pass and the upper portion of the device container are depicted.

FIG. 2 is a schematic perspective view of an outlet body without the cover thus allowing viewing the interior thereof.

FIG. 3 is an schematic plan view of an outlet body, showing the pin housings, the lower portion of the device container and the new location of the contacts.

FIG. 4 is a schematic plan view of an outlet body, similar to that of FIG. 3, but showing only the electrical circuit.

FIG. 5 is a schematic partial view of a housing modified for permitting actuation of the device.

FIG. 6 is a schematic perspective view of a pyramidal device wherein blocking arms, contacts intercrossing and the resilient means are shown.

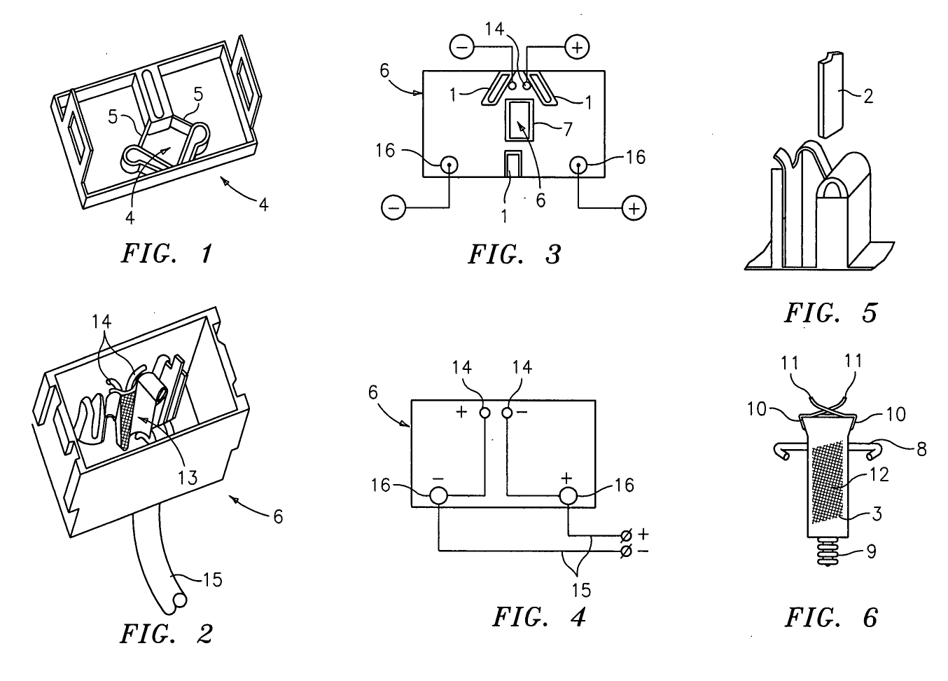

### REFERENCES

In the accompanying drawings the same reference numerals indicate the same or corresponding parts, as follows:
1—Housing
2—pin
3—device
4—cover
5—upper portion of a container
6—body
7—lower portion of the container
8—blocking arm
9—resilient means
10—rear portion
11—front portion
12—device grooving or knurling
13—grooving or knurling of the lower portion of the container
14—terminal
15—cable
16—terminal point.

### DETAILED DESCRIPTION OF THE PREFERRED EMBODIMENT(S)

Basically, the instant invention provides a safety system for current outlets comprised by a device projecting two blocking arms mating with the housings provided for the pins.

Such device also provides a resilient means at the lower base and at least one of its faces with a grooving or knurling.

At the opposite base of said device there are corresponding projections engaging contact points connected to the power supply.

### Operation

Once established the different components of the present embodiment of the invention, a functional and operational description of the parts and results afforded is given below.

In order to obtain a safety system for current outlets, fluorescent tube sockets, lamps holders and the like, some of such conventional elements is selected in order to proceed with its adaptation.

In the following description reference is made to a current outlet, merely for a better understanding of the invention without being limited to this embodiment.

In order to adapt a conventional outlet, a strip of insulating material coating housings 1 developed to contain pins 2 of a conventional plug is removed.

To fit device 3 such that it is sufficiently fixed once the outlet is assembled, at the cover 4 thereof the upper portion of a container 5 is formed, while in body 6 of said outlet the lower portion of a container 7 is formed.

Taking into account that the space within an outlet limited between housings 1 for pins 2 has variable shape according to the manufacturing practices, the applicant has studied such variations to limit the plan of the housing of the device 3.

Therefore, the inventor has determined that such plan is feasible in a triangular or quadrangular shape, thus having the device 3 container a plan having a triangle, square or rectangle shape.

Any of such forms for device 3 are appropriate in the invention and, in the annexed figures, a rectangular plan is shown in FIG. 3 and a device (3) with triangular bases is shown in FIG. 6.

The lower portion of container 7 is higher than the upper portion of container 5, thus allowing accommodation of more than a half of the device 3 therein.

Coinciding with the location of housings 1 for pins 2, such device 3 projects respective blocking arms 8 made of rigid, resistant material, at least its outer layer being an insulating layer.

At the lower base of the device 3, there is a resilient means 9 acting expansively to separate said lower base from the bottom of the container.

In turn, at the upper base of said device 3, there are corresponding contacts made of conductive material, each of which is located such that a rear portion 10 encompasses at least partially the side of device 3 and a front portion 11 projecting towards the front.

When a plug is introduced into the outlet, pins 2 will contact the blocking arms 8 biasing them downwardly, thus carrying in this way the device 3 engaged thereto.

In such case, resilient means 9 will begin compression accumulating energy which allows biasing device 3 upwardly when the plug is removed.

When a single pin 2 or any other object of conductive material is introduced, the corresponding blocking arm 8 will be interposed in this path, thus preventing the passage.

If someone introduces the object or the pin exerting increased pressure trying to force introduction, device 3 will be unbalanced and blocked against the container.

In order to improve gripping between device 3 and the container in cases such as that already described, at least on one of the faces of device 3 a grooving or knurling 12 will be provided, and on at least the face in front of the lower portion of the container 7 grooving or knurling will be also provided, mating with the former one.

If the object introduced has such a size that overcomes the action of the blocking arm 8, any point of housing 1 contacted will not be subjected to any consequence since none of the housings is connected to electric current.

In fact, originally, the conventional outlet has a housing 1 to ground and the two remaining housings are connected to any of the poles, negative or positive, of the power supply.

Therefore, if a conductive object were introduced into housing 1 of a conventional outlet, the circuit would close and the person involved would receive a discharge.

In the embodiment disclosed, housings 1 are merely receptors for pins 2 of the plug, since none of them is connected to the power supply.

For closing the circuit, pins 2 should bias the blocking arms 8 downwards, thus compressing the resilient means 9 and lowering device 3.

Upon lowering said device 3, front portions 11 of the contacts are connected to terminals 14 fed from the power supply and rear portions 10 of said contacts will engage the conductive portion of housings 1 closing the circuit and allowing current passage from the power supply, through terminals 14 and of front 11 and rear 10 portions of the contacts, thus reaching the metal (or conductive) portion of respective housings 1 and, from there, to pins 2 of the plug.

In the preferred embodiment disclosed, front portions 11 are intercrossed such that each of pins 2 of a plug, enables current passage from housing 1 which corresponds to the other pin 2.

In a preferred embodiment, device 3 has a widening at the upper end, such that rear portions (10) of the contacts project from the perimeter. In this embodiment, the rear portions 10 have a side the lower edge of which coincides with the body of device 3 while the upper edge is separated.

As described, when device 3 is lowered, rear portions 10 work as a wedge biasing the metal portion of housings 1 against pins 2 favoring retention of the pins.

Upon removing pins 2 from the plug, the side angle facilitates sliding of device 3 biased upwards by the resilient means 9.

In turn, the front portion 11 of the contacts engages terminals 14 tightly, thus pressing and forcing the position of the binding screws.

When pins 2 are removed, the resilient means 9 pushes device 3 upwards disengaging the contacts and making that terminals 14 return to their initial position due to elastic memory.

As may be seen in FIGS. 3 and 4, cable 15 connected to the power supply is bifurcated at its two poles such that each of the poles is connected to a terminal point 16 which is electrically connected to one of the terminals 14.

As seen in the mentioned figures, each terminal point 16 is displaced as compared to the location it would adopt in a conventional outlet, where it would be connected to one of the housings 1 and, for this reason, housings 1 of the system disclosed, will be only subjected to voltage when the front portions 11 of the contacts close the circuit engaging terminals 14.

In an alternative embodiment, said front portions 11 have a region in a plane parallel to the upper base of the device 3 and a final region located downwardly, while terminals 14 are within an insulating material housing such that their upper end is below the upper level of such housing.

In this embodiment, when pins 2 are introduced for lowering device 3, displacement of the latter downwards causes the ends of the final region of front portions 11 to be introduced into said housing and, within the housing, they contact terminals 14 for closing the circuit.

In a further alternative embodiment, under cover 4, there are corresponding laminar bodies preventing access of a body through the inlets of housings 1.

When an object is introduced into any housing 1, said laminar body intercepts his way.

The upper face of said laminar body faces the object or pin 2 but, since said face has a side recess, said object or pin 2 will be able to slide displacing the pin, this displacement being transmitted to the laminar body blocking passage through the other housing 1.

This drift caused by the remaining laminar body puts the recess of the upper face out of alignment and, therefore, the object or pin 2 will abut against a planar portion of said laminar body, which will prevent its passage.

Upon removal of the plug, both laminar bodies will return to their original positions due to the action of corresponding springs.

In a preferred embodiment, all faces of device 3 are provided with a grooving or knurling 12 and all faces of the container are provided with a grooving or knurling 13.

The invention has been described in connection with one of the constructive possibilities of the invention and with its operation, the scope of the invention being only limited by the appended claims.

What is claimed is:

1. Safety system for current outlets, fluorescent tube sockets, lamp holders and the like, comprising a base, terminals for connection to positive and negative poles of a power supply, said terminals comprising a ground terminal and housings for pins of a plug, wherein from a device housed in a container formed between the housings, respective arms project outwardly blocking at least two of said housings, said device providing, at a lower base, a resilient means separating the device from a bottom of the container and, at an upper base, corresponding contacts, each of said contacts has a rear portion encompassing at least partially a side of the device side and a front portion projecting to the front and intercrossing the front portion of the remaining contact, the displacement of the device compressing the resilient means and engaging the rear portion of the contacts with a metal portion of a corresponding housing and the front portion thereof with corresponding terminals electrically engaged to respective terminal points of power supply cables, thus closing the circuit.

2. System as claimed in claim 1, wherein pressure exerted simultaneously by the pins on said blocking arms displaces the device downwardly thus compressing the resilient means between the device and the bottom of a lower portion of the container.

3. System as claimed in claim 1, wherein the container formed between housings of a current outlet is integrated with an upper portion engaged to a cover and a lower portion engaged to an outlet body, the lower portion of which is higher than the upper portion, accommodating more than half of the device therein.

4. System as claimed in claim 1, wherein the resilient means acts by expansion.

5. System as claimed in claim 1, wherein the housings have a recess mating with the position of the respective blocking arm.

6. System as claimed in claim 1, wherein the front portions of the contacts have a region in a plane parallel to an upper base of the device and a final region located downwards, and the terminals are placed inside an insulating material housing with their upper ends being below an upper level of the housing, and the circuit being closed therein.

7. System as claimed in claim 1, wherein said blocking arms are made of a rigid, resistant material, and at least an outer layer thereof is an insulating layer.

8. System as claimed in claim 1, wherein the device has at least one face provided with a grooving which mates with a grooving of a subsequent face of the container.

9. System as claimed in claim 1, wherein the device has a widening at an upper end, such that the rear portions of the contacts project from the perimeter and, when the device is pushed downwards, they engage and displace a metal portion of the housing.

10. System as claimed in claim 2, wherein the device has a widening at an upper end such that the rear portions of the contacts project therefrom.
